(19) United States
(12) Patent Application Publication
(10) Pub. No.: US 2018/0157097 A1
(43) Pub. Date: Jun. 7, 2018

(54) Shielding Adhesive Tape, Display Apparatus Using the Tape and Method for Producing the Tape

(71) Applicants: BOE Technology Group Co., Ltd., Beijing (CN); Beijing BOE Optoelectronics Technology Co., Ltd, Beijing (CN)

(72) Inventors: Dong Wang, Beijing (CN); Jian Ren, Beijing (CN); Dawei Wang, Beijing (CN)

(21) Appl. No.: 15/551,658

(22) PCT Filed: Feb. 16, 2017
(86) PCT No.: PCT/CN2017/073777

§ 371 Date: Aug. 17, 2017

(30) Foreign Application Priority Data
Jul. 18, 2016 (CN) 201610565408.2

(51) Int. Cl. G02F 1/1335

(52) U.S. Cl. CPC G02F 1/133512; G02B 6/0053; G02F 1/133528

(57) ABSTRACT

Embodiments of the present disclosure provide a shielding adhesive tape, a display apparatus using the shielding adhesive tape and a method for producing the shielding adhesive tape. The shielding adhesive tape includes: a shielding adhesive tape body; and a first mold releasing film adhered to a first surface of the shielding adhesive tape body, wherein the first mold releasing film includes at least one cutting line which defines a remaining part on the first mold releasing film and wherein the remaining part is crackable from the cutting line and is remained on the shielding adhesive tape body during tearing the first mold releasing film away from the shielding adhesive tape body.

### CROSS-REFERENCE TO RELATED APPLICATION

This application claims benefit of the Chinese Patent Application No. 201610565408.2, filed with SIPO on 18 Jul. 2016, entitled with “shielding adhesive tape, display apparatus using the tape and method for producing the tape”, which is incorporated herein by reference in entirety.

### BACKGROUND OF THE DISCLOSURE

### Field of the Disclosure

The present disclosure relates to the field of display technology, and in particular, to a shielding adhesive tape, a display apparatus using the shielding adhesive tape and a method for producing the shielding adhesive tape.

### Description of the Related Art

In the prior, light leak issues of a backlight module can be solved by providing a shielding adhesive tape between a back plate of the backlight module and an edge of a lower surface of a display panel. However, the shielding adhesive tape may typically be adhered with the display panel, which may cause defects of bright and dark spots in front of lamps of the backlight module.

### SUMMARY

At least a part of an object of the present disclosure is to provide a shielding adhesive tape, a display apparatus using the shielding adhesive tape and a method for producing the shielding adhesive tape.

In accordance with an aspect of the present disclosure, it provides a shielding adhesive tape for a display apparatus, including:

a shielding adhesive tape body; and

a first mold releasing film adhered to a first surface of the shielding adhesive tape body;

wherein the first mold releasing film includes at least one cutting line which defines a remaining part on the first mold releasing film and wherein the remaining part is crackable from the cutting line and is remained on the shielding adhesive tape body during tearing the first mold releasing film away from the shielding adhesive tape body.

In an embodiment, the cutting line is a closed cutting line which defines the remaining part on the first mold releasing film separately.

In an embodiment, the cutting line is an opened cutting line which cooperates with a corresponding side of the first mold releasing film to define the remaining part.

In an embodiment, the first surface of the shielding adhesive tape body has an adhesive layer and the first mold releasing film is adhered to the shielding adhesive tape body by the adhesive layer of the first surface.

In an embodiment, the adhesive layer is a black light absorption adhesive layer containing light absorption additives.

In an embodiment, the remaining part has a shape selected from one of a strip, a rectangle, a circle or an ellipse, or a shape of a combination selected from more of them.

In an embodiment, the shielding adhesive tape body has a form of a frame and includes at least one wide lateral side region, wherein the at least one cutting line is located at a side of the first mold releasing film corresponding to the at least one wide lateral side region.

In an embodiment, the remaining part has a shape of strip and has a width between 2 mm and 10 mm, and the remaining part has a lengthwise direction extending along the wide lateral side region.

In an embodiment, there are two to four remaining parts on the first mold releasing film.

In an embodiment, the first mold releasing film further has a tearing portion and the at least one cutting line is located on a side of the first mold releasing film close to the tearing portion.

In an embodiment, the tearing portion is configured to tear the first mold releasing film away from the shielding adhesive tape body when it is applied by a force while the remaining part is cracked from the cutting line and remained on the shielding adhesive tape body.

In an embodiment, the first mold releasing film has thickness between 0.02 mm and 0.1 mm.

In an embodiment, the shielding adhesive tape body is a PET shielding layer and the first mold releasing film is a PET single sided mold releasing film.

In an embodiment, the shielding adhesive tape further includes: a second mold releasing film adhered to a second surface of the shielding adhesive tape body and the second surface is opposed to the first surface.

In an embodiment, the second surface of the shielding adhesive tape body has an adhesive layer and the second mold releasing film is adhered to the shielding adhesive tape body by the adhesive layer of the second surface, and wherein the adhesive layer is a black light absorption adhesive layer containing light absorption additives.

In an embodiment, the second mold releasing film is a PET single sided mold releasing film.

In accordance with another aspect of the present disclosure, it provides a display apparatus, including:

a display panel;

a backlight module; and

the shielding adhesive tape as described above sandwiched between the display panel and the backlight module.

In an embodiment, the display panel includes a lower polarizer and an array substrate arranged sequentially from its light incidence side towards its light exit side, the lower polarizer having a lateral side located in a side of the array substrate facing towards the backlight module, and wherein there is a step structure formed between the lower polarizer and the array substrate;

wherein the shielding adhesive tape body is located on the backlight module and the remaining part of the first mold releasing film is sandwiched between the shielding adhesive tape body and the array substrate and the following inequality is satisfied:

30 μm≤(h₂−h₁)≤50 μm

wherein h₂ is a thickness of the lower polarizer and h₁ is a thickness of the remaining part of the first mold releasing film.

In accordance with another aspect of the present disclosure, it provides a method for producing a display apparatus, including:

providing a backlight module;

adhering the shielding adhesive tape described above on the backlight module;

tearing the first mold releasing film while the remaining part defined by a cutting line on the first mold releasing film is cracked at the cutting line and remained on the shielding adhesive tape body; and

mounting a display panel above the shielding adhesive tape body and the remaining part of the first mold releasing film, wherein the shielding adhesive tape body separates the display panel from the backlight module and the remaining part of the first mold releasing film separates the shielding adhesive tape body from the display panel.

In an embodiment, the method further includes a step of tearing away the second mold releasing film below the shielding adhesive tape body of the shielding adhesive tape before adhering the shielding adhesive tape to the backlight module.

### BRIEF DESCRIPTION OF THE DRAWINGS

FIG. 1 is a schematic view showing a shielding adhesive tape with a single sided adhesive tape adhered thereon according to an embodiment of the present disclosure;

FIG. 2A is a schematic view showing a structure of a shielding adhesive tape according to another embodiment of the present disclosure;

FIG. 2B is a schematic view showing a shielding adhesive tape as shown in FIG. 2A adhered to a backlight module after a second mold releasing film is torn away;

FIG. 2C is a schematic view showing a shielding adhesive tape in which a first mold releasing film is torn away from the arrangement as shown in FIG. 2B;

FIG. 3A is a schematic view showing a structure of a shielding adhesive tape according to another embodiment of the present disclosure;

FIG. 3B is a schematic view showing the shielding adhesive tape body of the shielding adhesive tape shown in FIG. 3A after the first mold releasing film and the second mold releasing film are torn away;

FIG. 4A is a schematic view showing a structure of a shielding adhesive tape according to a further embodiment of the present disclosure;

FIG. 4B is a schematic view showing the shielding adhesive tape body of the shielding adhesive tape shown in FIG. 4A after the first mold releasing film and the second mold releasing film are torn away;

FIG. 5A is a schematic view showing a structure of a shielding adhesive tape according to a yet further embodiment of the present disclosure;

FIG. 5B is a schematic view showing the shielding adhesive tape body of the shielding adhesive tape shown in FIG. 5A after the first mold releasing film and the second mold releasing film are torn away;

FIG. 6A is a schematic view showing a structure of a shielding adhesive tape according to another embodiment of the present disclosure;

FIG. 6B is a schematic view showing the shielding adhesive tape body of the shielding adhesive tape shown in FIG. 6A after the first mold releasing film and the second mold releasing film are torn away;

FIG. 7 is a schematic view showing the shielding adhesive tape body with irregular shape of the shielding adhesive tape according to a yet further embodiment of the present disclosure after the first mold releasing film is torn away;

FIG. 8 is a schematic view showing a structure of a display apparatus according to an embodiment of the present disclosure; and

FIG. 9 is a flow chart schematically showing a method for producing a display apparatus according to an embodiment of the present disclosure.

### DETAILED DESCRIPTION OF PREFERRED EMBODIMENTS OF THE DISCLOSURE

Embodiments of the present disclosure will below be explained clearly and entirely with reference to drawings, such that the object, the technical solutions and advantages of the present disclosure become more explicit.

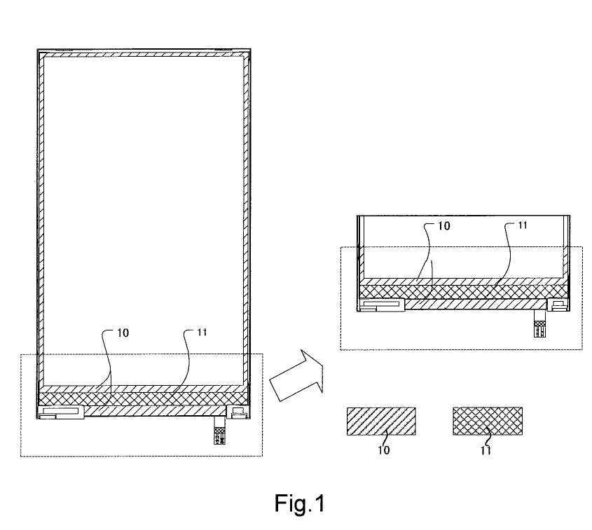

Regarding the technical problem discussed in BACKGROUND OF THE DISCLOSURE, an embodiment of the present disclosure proposes out a solution, that is, a single sided adhesive tape or a PET (Polyethylene terephthalate) film 11 adhered additionally on a shielding adhesive tape 10 arranged at the light incidence side of the backlight module, as shown in FIG. 1.

However, not only the single sided adhesive tape or PET film 11 adhered additionally increases the cost of material, but also the shielding adhesive tape 10 and the single sided adhesive tape 11 need to be assembled separately to cause low efficiency and enhance the labor cost of the display apparatus indirectly.

In the following embodiments of the present disclosure, the design concept different from the above embodiments is used: a mold releasing film of the shielding adhesive tape is processed to form a cutting line at the position where the single sided adhesive tape would be adhered; in use, the mold releasing film is torn away and the remaining part to be needed may be cracked from the cutting line, so as to save the cost of single sided adhesive tape and the time for establishing the single sided adhesive tape.

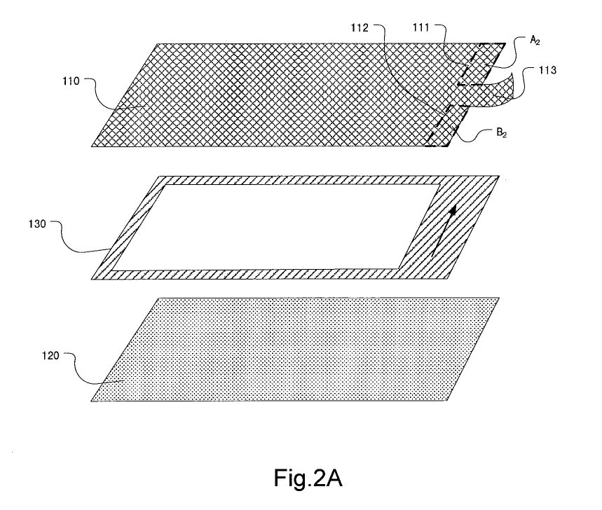

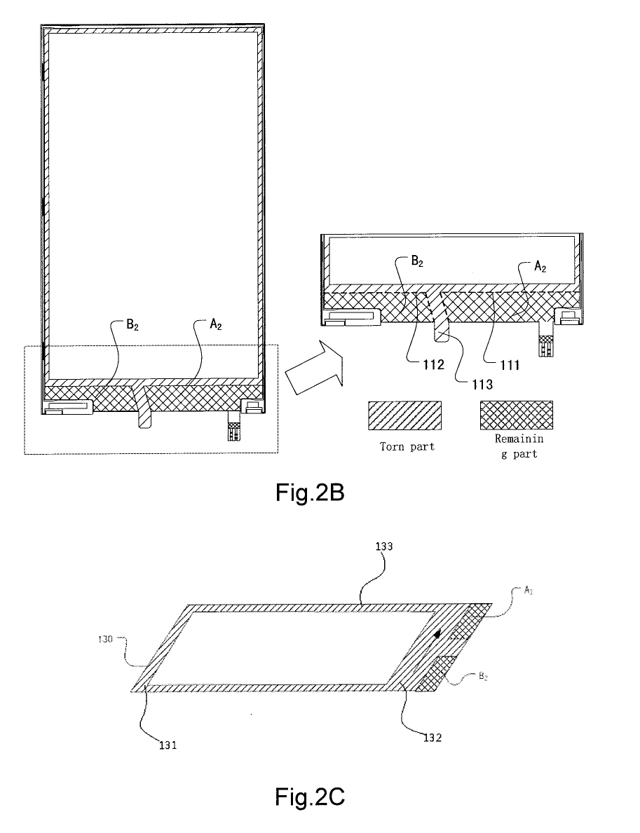

Another embodiment of the present disclosure provides a shielding adhesive tape. With reference to FIG. 2A, the shielding adhesive tape 100 includes a shielding adhesive tape body 130; and a first mold releasing film 110 and a second mold releasing film 120 adhered to both sides of the shielding adhesive tape body 130.

It should be noted that in FIG. 2A, for the sake of clarity, the first mold releasing film 110, the second mold releasing film 120 and the shielding adhesive tape body 130 are represented as three separate layers. However, in fact, when it is not used, the first mold releasing film 110, the second mold releasing film 120 and the shielding adhesive tape body 130 are adhered together. And there are no gaps between adjacent ones of them.

When the shielding adhesive tape is not used, the shielding adhesive tape body 130 is sandwiched between the first mold releasing film 110 and the second mold releasing film 120. When the shielding adhesive tape is used, the second mold releasing film 120 is torn away and the shielding adhesive tape body 130 and the first mold releasing film 110 are adhered to an adhesive frame of the backlight module, as shown in FIG. 2B.

As illustrated in FIG. 2A and FIG. 2B, two cutting lines 111, 112 are formed on the first mold releasing film 110. The cutting lines 111, 112 and a bottom side and lateral sides of the first mold releasing film 110 define a remaining part of the first mold releasing film, as represented by A₂ and B₂. Other parts except the remaining part may be regarded as a torn part of the first mold releasing film. When the first mold releasing film 110 is torn away in use, the remaining part A₂ corresponding to the cutting line 111 and the remaining part B₂ corresponding to the cutting line 112 are cracked at the respective cutting lines and remained on the shielding adhesive tape body 130, as shown in FIG. 2C. The torn parts of the first mold releasing film 110 other than the remaining parts A₂ and B₂ are torn away.

The respective parts of the shielding adhesive tape in the embodiment will be explained below in details.

As seen in FIG. 2A, the shielding adhesive tape 100 in the embodiment includes the shielding adhesive tape body 130; and the first mold releasing film 110 and the second mold releasing film 120 adhered to both sides of the shielding adhesive tape body 130.

The skilled person in the art would appreciate that the second mold releasing film 120 below the shielding adhesive tape body 130 may be omitted or not be provided if the cleanliness of the back face of the shielding adhesive tape body 130 is not considered. Thus, in other embodiments of the present disclosure, the shielding adhesive tape may only include: the shielding adhesive tape body 130 and the first mold releasing film 110 adhered to a front face of the shielding adhesive tape body 130.

In order to adhere the shielding adhesive tape body 130 to the upper first mold releasing film 110 and the lower second mold releasing film 120, the shielding adhesive tape body 130 may be a double sided adhesive tape and has an upper surface and a lower surface. Adhesive layers 131 are formed on both the upper surface and the lower surface. The first mold releasing film 110 is adhered to the upper surface of the shielding adhesive tape body 130 by the adhesive layer 131 on the upper surface of the shielding adhesive tape body 130. The second mold releasing film 120 is adhered to the lower surface of the shielding adhesive tape body 130 by the adhesive layer on the lower surface of the shielding adhesive tape body 130.

In the embodiment, the shielding adhesive tape body 130 is a PET shielding layer 131 with black light absorption adhesive layers 131 on its two sides. The first mold releasing film 110 and the second mold releasing film 120 are PET single sided mold releasing films. The above black light absorption adhesive layers 131 are adhesive layers containing light absorption additives and configured mainly to absorb the light irradiated on the shielding adhesive tape body 130 from the backlight module, so as to avoid bright edge effects.

It can be understood that materials of the shielding adhesive tape body 130, the first mold releasing film 110 and the second mold releasing film 120 may be selected reasonably according to process parameters and costs without being limited to the special materials provided by the embodiment.

It should be understood that the shielding adhesive tape body 130 and the mold releasing film may be adhered tightly to each other by means of atmosphere pressure if the surface of the shielding adhesive tape body 130 and the opposed surface of the mold releasing film are clean sufficiently. In such case, the adhesive layers 131 on the shielding adhesive tape body 130 may also be omitted.

In the shielding adhesive tape 110 shown in FIG. 2A, the cutting lines 111, 112 and the bottom side of the first mold releasing film 110 cooperate with each other to remain the remaining parts. However, embodiments of the present disclosure are not limited to this. In other embodiments of the present disclosure, the cutting lines 111, 112 may also be closed by themselves, that is, they are closed cutting lines. In this case, the closed cutting lines may define the remaining part separately without using the corresponding lateral sides or bottom side of the first mold releasing film 110.

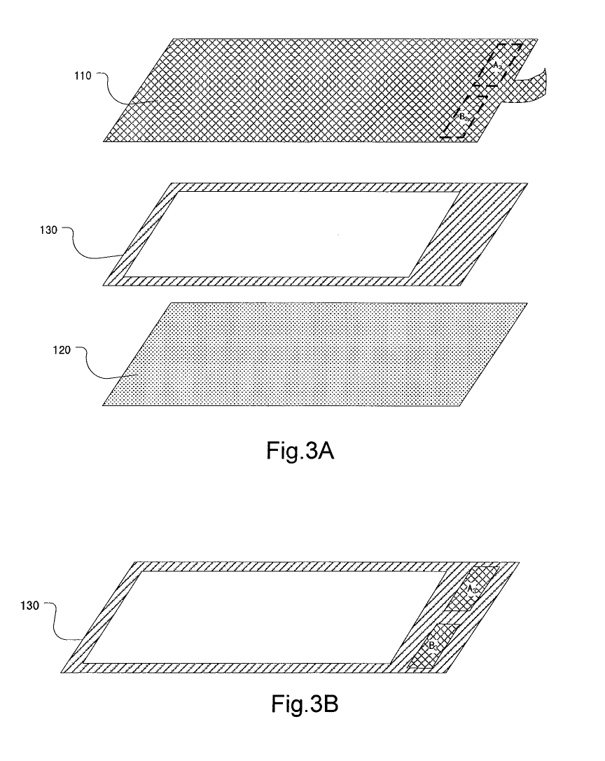

FIG. 3A is a schematic view showing a structure of a shielding adhesive tape according to another embodiment of the present disclosure. Other than the shielding adhesive tape shown in FIG. 2A, two closed cutting lines are formed on the first mold releasing film 110 in the shielding adhesive tape shown in FIG. 3A. Each of the closed cutting lines defines a remaining part in a form of strip. After the first mold releasing film is torn away, two remaining parts in form of strips A₃, B₃ are remained on the shielding adhesive tape body 130, as shown in FIG. 3B.

In the shielding adhesive tape shown in FIG. 2A, two remaining parts of the first mold releasing film 110 are formed on the shielding adhesive tape body 130, i.e., the remaining part A₂ and the remaining part B₂ respectively. And the remaining part A₂ and the remaining part B₂ both have form of strips. In fact, in order to prevent the shielding adhesive tape 100 from being adhered to a liquid crystal display panel and to improve the convenience of the process and operation, the remaining parts on the first mold releasing film 110 may also be provided as the forms of strips and in an example, the remaining parts in the forms of strips have widths between 2 mm and 10 mm and have lengthwise direction extending along wide lateral side region on the shielding adhesive tape body 130. The extending direction of the wide lateral side region on the first mold releasing film 110 is indicated by arrows shown in FIG. 2A and FIG. 2C.

It can be understood that in other embodiments of the present disclosure, there may also be a plurality of remaining parts which may be designed as other forms of such as square, circle.

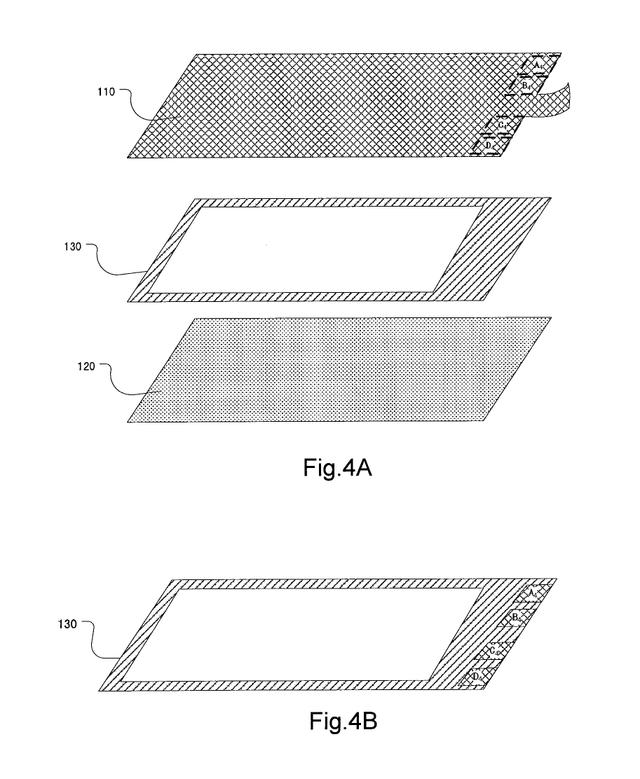

FIG. 4A is a schematic view showing a structure of a shielding adhesive tape according to a further embodiment of the present disclosure. In the shielding adhesive tape shown in FIG. 4A, four opened cutting lines are formed on the first mold releasing film 110. Each of the opened cutting lines cooperates with the bottom side of the first mold releasing film 110 to define a remaining part in a form of square. After the first mold releasing film 110 is torn away, four remaining parts A₄, B₄, C₄, D₄ in forms of squares are remained on the shielding adhesive tape body 130, as shown in FIG. 4B.

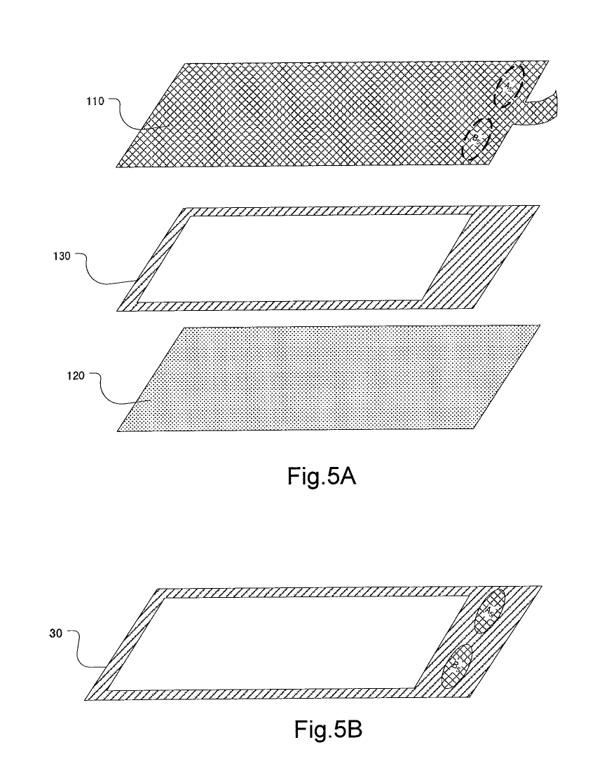

FIG. 5A is a schematic view showing a structure of a shielding adhesive tape according to a yet further embodiment of the present disclosure. In the shielding adhesive tape shown in FIG. 5A, two closed cutting lines are formed on the first mold releasing film 110. Each of the closed cutting lines defines a remaining part in a form of ellipse. After the first mold releasing film 110 is torn away, two remaining parts A₅, B₅ in forms of ellipses are remained on the shielding adhesive tape body 130, as shown in FIG. 5B.

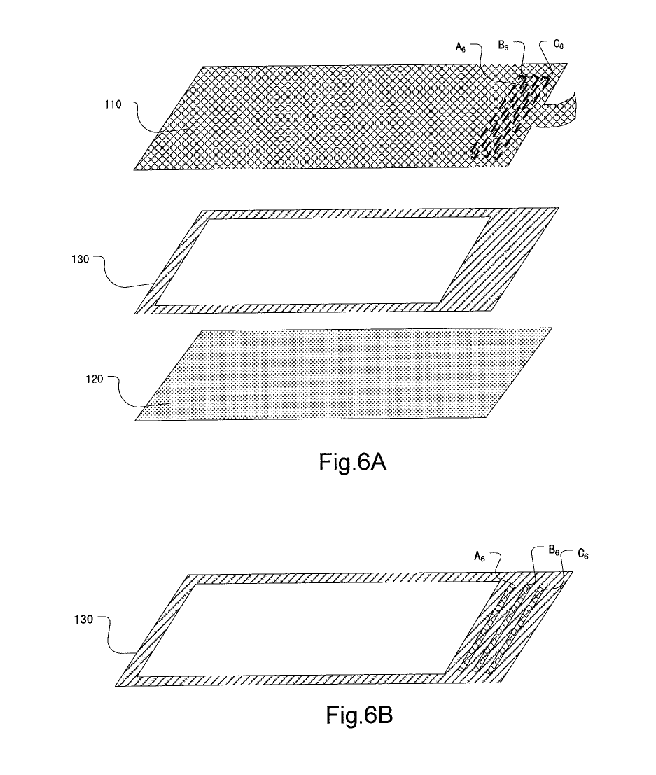

FIG. 6A is a schematic view showing a shielding adhesive tape according to another embodiment of the present disclosure. In the shielding adhesive tape shown in FIG. 6A, three closed cutting lines in form of strips are formed on the first mold releasing film 110. Each of the closed cutting lines in form of strips defines a remaining part in a form of strip. After the first mold releasing film 110 is torn away, three remaining parts A₆, B₆, C₆ in forms of strips are remained on the shielding adhesive tape body 130, as shown in FIG. 6B.

In the shielding adhesive tape shown in FIG. 2A, the shielding adhesive tape body 130 has a form of a frame having four sides and includes a wide lateral side region 132 and three narrow lateral side regions 133. The wide lateral side region 132 corresponds to the light source side of the backlight module. On the first mold releasing film 110, the remaining part A₂ and the remaining part B₂ are arranged on a side corresponding to the wide lateral side region 132 of the shielding adhesive tape body 130. However, embodiments of the present disclosure are not limited to this. In other embodiments of the present disclosure, the shielding adhesive tape body 130 may also be various regular shapes such as circular frame, polygonal frame. Alternatively, the shielding adhesive tape body 130 may also be in an irregular shape.

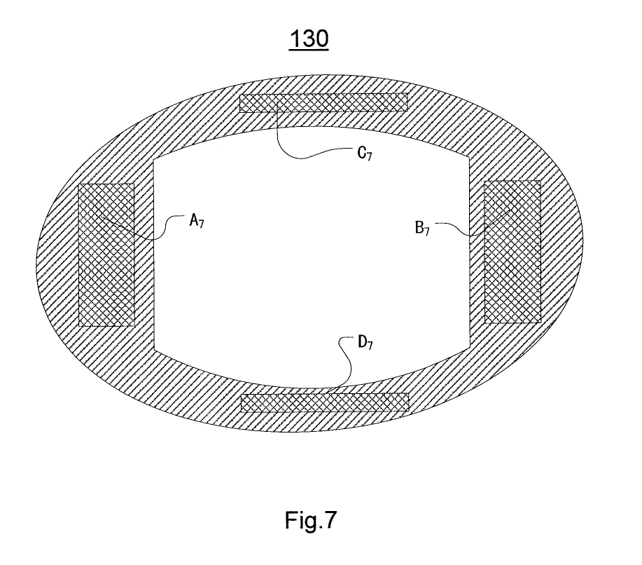

FIG. 7 is a schematic view showing the shielding adhesive tape body 130 with irregular shape of the shielding adhesive tape according to a yet further embodiment of the present disclosure after the first mold releasing film 110 is torn away. Seen from FIG. 7, the shielding adhesive tape body 130 is in a form of an irregular frame. On wide lateral side regions on left and right two sides, two remaining parts, i.e., the remaining part A₇, the remaining part B₇ are remained after the first mold releasing film is torn away. Further, the remaining part C₇ and the remaining part D₇ are also formed on the upper and lower narrow lateral side regions.

In addition, the skilled person in the art would appreciate that the whole shapes of the first mold releasing film and the second mold releasing film are not limited to the rectangles shown in FIG. 2A. In view of the mechanical strength and production cost, the first mold releasing film and the second mold releasing film may be produced into various suitable shapes.

In addition, referring back to FIG. 2A and FIG. 2C, in order to tear away the first mold releasing film conveniently, a tearing portion 113 extending beyond the display apparatus is provided on the first mold releasing film. After the shielding adhesive tape body 130 and the first mold releasing film 110 are adhered to the adhesive frame of the backlight module, the torn part of the first mold releasing film 110 other than the remaining part may be torn away by pulling out the tearing portion 113 while the remaining parts are remained on the shielding adhesive tape body 130.

The skilled person in the art would appreciate that the tearing portion 113 may be arranged at any position which is at outside of the first mold releasing film 110 and connected to the torn part, for example, at the upper side, at the lower side, at the left side or at the right side. In an example, the tearing portion may have a length between 0.5 cm and 1.5 cm, such that the operator can apply a force without any specialized devices; certainly, the force may also be applied alternatively by a suitable tool as required. For example, on the first mold releasing film 110, the cutting line is arranged on a side of the tearing portion 113. In this way, it may avoid risk that the torn part on the first mold releasing film 110 takes away the remaining part when it is torn.

It should be noted that, besides the function of preventing the shielding adhesive tape 100 and the liquid crystal display panel from being adhered to each other, the remaining part of the first mold releasing film 110 remained on the shielding adhesive tape body 130 may also have additional functions: partly compensating difference in thickness between the lower polarizer and the array substrate.

The thickness of the lower polarizer is approximately in a range of 0.05 mm to 0.15 mm. In an example, the thickness h₁ of the first mold releasing film is 30 μm to 50 μm smaller than the thickness h₂ of the lower polarizer. In practical assembling, the remaining part of the first mold releasing film is arranged at a step between the lower polarizer and the array substrate. In production, the array substrate may be subject to a downward pressure. When the array substrate is pressed downwardly to some extent, the remaining part of the first mold releasing film 110 may produce a certain function of supporting the array substrate, so as to enhance the strength of whole structure of the backlight module and the display panel.

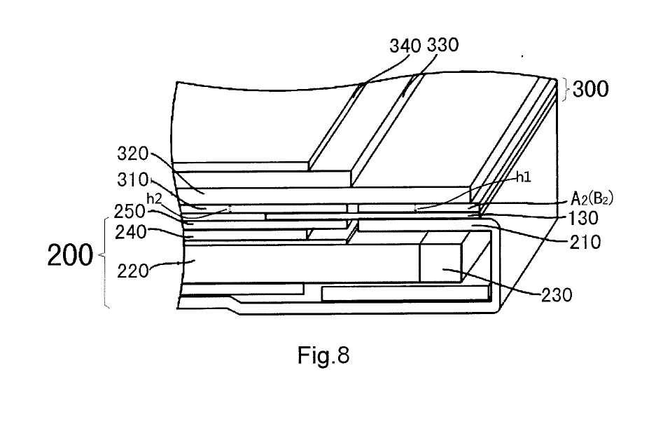

Based on the above shielding adhesive tape, another embodiment of the present disclosure also provides a display apparatus. As illustrated in FIG. 8, the display apparatus includes: a display panel 300; a backlight module 200; and the shielding adhesive tape body 130 and the remaining parts A₂, B₂ of the first mold releasing film 110 in the shielding adhesive tape 100 sandwiched between the display panel and the backlight module.

In an example, the backlight module 200 includes: a back plate 210; a light guide plate 220 and a light bar 230 arranged in the back plate 210; a prism 240 arranged in the back plate 210 and between the light guide plate 220 and the display panel 300; and a protection layer 250 arranged between the prism 240 and the display panel 300.

In an example, the display panel 300 includes a lower polarizer 310, an array substrate 320, a color filter substrate 330 and an upper polarizer 340 arranged sequentially from its light incidence side towards its light exit side.

The shielding adhesive tape body 130 of the shielding adhesive tape 100 is arranged along an edge of the display panel and sandwiched between the backlight module 200 and the display panel 300. In particular, the shielding adhesive tape body 130 is sandwiched between the back plate 210 of the backlight module 200 and the protection layer 250 and the lower polarizer 310 and the array substrate 320 of the display panel 300. The shielding adhesive tape body 130 spaces the display panel 300 apart from the backlight module 200 by a distance, so as to prevent them from being adhered to each other and avoid the effect of bright and dark spots in front of lamps of the backlight module 200.

When the lateral side of the lower polarizer 310 at a light incidence edge is located in the lateral side of the array substrate 320 facing towards the backlight module 200 and a step structure is formed between the lower polarizer 310 and the array substrate 320, the remaining parts A₂, B₂ of the first mold releasing film 110 on the shielding adhesive tape 100 is sandwiched between the shielding adhesive tape body 130 and the array substrate 320 and the thickness h₁ of the remaining parts A₂, B₂ of the first mold releasing film 110 is 30 μm to 50 μm less than the thickness h₂ of the lower polarizer. In this case, the remaining parts A₂, B₂ of the first mold releasing film may partly compensate the difference in thickness between the lower polarizer 310 and the array substrate 320, such that the outer side of the array substrate 320 can be supported stably when a force is applied, so as to enhance the strength of the whole structure of the display apparatus.

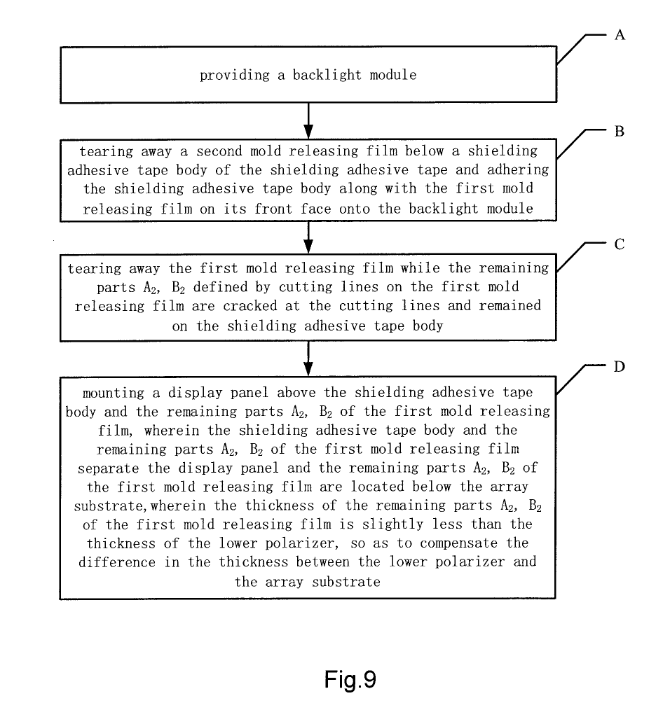

The method for producing the display apparatus shown in FIG. 8 is provided below. As illustrated in FIG. 2A to FIG. 2C, FIG. 8 and FIG. 9, the method for producing the display apparatus includes:

Step A: providing or producing the backlight module 200;

Step B: tearing away the second mold releasing film 120 below the shielding adhesive tape body 130 of the shielding adhesive tape 100 and adhering the shielding adhesive tape body 130 along with the first mold releasing film 110 on its front face onto the backlight module 200;

Step C: tearing away the first mold releasing film 110 while the remaining parts A₂, B₂ defined by cutting lines on the first mold releasing film 110 are cracked at the cutting lines and remained on the shielding adhesive tape body 130; and

Step D: mounting a display panel 300 above the shielding adhesive tape body 130 and the remaining parts A₂, B₂ of the first mold releasing film, wherein the shielding adhesive tape body 130 and the remaining parts A₂, B₂ of the first mold releasing film separate the display panel 300 from the backlight module 200 and the remaining parts A₂, B₂ of the first mold releasing film 110 are located below the array substrate 320. The thickness of the remaining parts A₂, B₂ of the first mold releasing film 110 is equal to or slightly less than the thickness of the lower polarizer 310, so as to compensate the difference in the thickness between the lower polarizer 310 and the array substrate 320.

In an example, the thickness h₁ of the remaining parts A₂, B₂ of the first mold releasing film 110 is 30 μm to 50 μm less than the thickness h₂ of the lower polarizer 310, as discussed in above relative description.

Certainly, as required, the display apparatus and the method for producing the same according to the present disclosure further include other components, processes or steps. The details will be omitted herein.

It should be noted that implementations that are not described or illustrated in drawings or the literal description are the known forms for the skilled person in the art and thus the details are omitted. Further, the above definitions to various elements and methods are not limited to only the respective specific structures, shapes or forms discussed in the embodiments. The skilled person in the art may modify or replace them easily, for example:

(1) materials of the shielding adhesive tape body, the first mold releasing film and the second mold releasing film on the shielding adhesive tape are not limited to the special materials given in the embodiments, which can be selected by the skilled person in the art from the transparent macromolecule materials as required;

(2) the skilled person in the art can reasonably select number, shape, size and position of the remaining parts on the first mold releasing film, which is not limited to the forms given in the embodiments;

(3) the structures and compositions of the display panel and the backlight module in the display apparatus are not limited to the special forms given in the embodiments, and the present disclosure may also be adapted for the display apparatus with other structures.

In addition, it should also be noted that examples of the parameters containing special values may be provided, however, these parameters need not be equal to the respective values exactly, but approximate the respective values in an acceptable tolerance of error or design constraint. The terms regarding directions discussed in the embodiments, for example, such as “above”, “down”, “front”, “back”, “left”, “right” are only intended to represent directions of the reference drawings, instead of limiting the protection scope of the present disclosure. Further, the sequence of the above steps is not limited to the above list and may be modified or rearranged as designed unless these steps are described specially or have to be performed in sequence. The above embodiments may be combined with each other or combined with other embodiments in consideration of design and reliability, that is, the technical features in different embodiments may be combined freely to form more embodiments.

As discussed above, in a plurality of embodiments of the present disclosure, the mold releasing film of the shielding adhesive tape is processed to form cutting lines at the position that needs to be adhered to the single sided adhesive tape. When the mold releasing film is torn away in use, the remaining part to be needed may be cracked from cutting lines. It may save the costs of the single sided adhesive tape and time of establishing the single sided adhesive tape, so as to reduce the costs of the backlight source.

It can be seen from the technical solutions provided by the above embodiments that in the present disclosure the shielding adhesive tape, the display apparatus using the shielding adhesive tape and the method for producing the shielding adhesive tape have at least one of the following advantageous effects:

(1) a new type shielding adhesive tape which is different from the past is provided;

(2) the same function may be achieved only by simple tearing operation without adding processes of adhering the single sided adhesive tape or PET film additionally, thereby improving the convenience of the operation and saving the time costs and labor costs;

(3) the cutting lines are added at a preset position when the shielding adhesive tape is produced such that the costs of the shielding adhesive tape and even the whole display apparatus increases very few and can be neglected nearly;

(4) the shape and size of the remaining parts of the first mold releasing parts can be flexibly arranged from the functional area of the relative region on the backlight module and the display panel, which is more flexible in comparison with the single sided adhesive tape (or the PET film);

(5) the remaining parts of the first mold releasing film defined by the cutting lines have forms of strips which have width between 2 mm and 10 mm and can be torn easily, thereby further saving the time costs and labor costs;

(6) the remaining parts of the first mold releasing film defined by the cutting lines are cracked at the cutting lines and still remained on the shielding adhesive tape body, which have the same function as the single sided adhesive tape or the PET film, so as to avoid the defects of bright and dark spots in front of lamps of the backlight module caused by adhering the shielding adhesive tape to the display panel without any substantive influences on the display effects;

(7) the remaining parts of the first mold releasing film remained on the shielding adhesive tape body are located on a step structure between the lower polarizer and the array substrate of the display panel and the thickness of the remaining parts is slightly less than the thickness of the lower polarizer such that when the upper array substrate is pressed, the remaining parts may produce a certain function of supporting the array substrate, so as to enhance the strength of whole structure of the backlight module and the display panel.

Through the above embodiments, the object, the technical solutions and advantageous effects of the present disclosure have been explained. It should be understood that the above embodiments are exemplary embodiments of the present disclosure, instead of limiting the protection scope of the present disclosure. All of modifications, alternatives and improvements made without departing from the principles and spirit of the disclosure should fall within the protection scope of the present disclosure.

1. A shielding adhesive tape for a display apparatus, comprising:
a shielding adhesive tape body; and
a first mold releasing film adhered to a first surface of the shielding adhesive tape body;
wherein the first mold releasing film comprises at least one cutting line which defines a remaining part on the first mold releasing film and wherein the remaining part is crackable from the cutting line and is remained on the shielding adhesive tape body during tearing the first mold releasing film away from the shielding adhesive tape body.

2. The shielding adhesive tape according to claim 1, wherein the cutting line is a closed cutting line which defines the remaining part on the first mold releasing film separately.

3. The shielding adhesive tape according to claim 1, wherein the cutting line is an opened cutting line which cooperates with a corresponding side of the first mold releasing film to define the remaining part.

4. The shielding adhesive tape according to claim 1, wherein the first surface of the shielding adhesive tape body has an adhesive layer and the first mold releasing film is adhered to the shielding adhesive tape body by the adhesive layer of the first surface.

5. The shielding adhesive tape according to claim 4, wherein the adhesive layer is a black light absorption adhesive layer containing light absorption additives.

6. The shielding adhesive tape according to claim 1, wherein the remaining part has a shape selected from one of a strip, a rectangle, a circle or an ellipse, or a shape of a combination selected from more of them.

7. The shielding adhesive tape according to claim 1, wherein the shielding adhesive tape body has a form of a frame and comprises at least one wide lateral side region, wherein the at least one cutting line is located at a side of the first mold releasing film corresponding to the at least one wide lateral side region.

8. The shielding adhesive tape according to claim 7, wherein the remaining part has a shape of strip and has a width between 2 mm and 10 mm, and the remaining part has a lengthwise direction extending along the wide lateral side region.

9. The shielding adhesive tape according to claim 1, wherein there are two to four remaining parts on the first mold releasing film.

10. The shielding adhesive tape according to claim 1, wherein the first mold releasing film further has a tearing portion and the at least one cutting line is located on a side of the first mold releasing film close to the tearing portion.

11. The shielding adhesive tape according to claim 10, wherein the tearing portion is configured to tear the first mold releasing film away from the shielding adhesive tape body when it is applied by a force while the remaining part is cracked from the cutting line and remained on the shielding adhesive tape body.

12. The shielding adhesive tape according to claim 1, wherein the first mold releasing film has thickness between 0.02 mm and 0.1 mm.

13. The shielding adhesive tape according to claim 1, wherein the shielding adhesive tape body is a PET shielding layer and the first mold releasing film is a PET single sided mold releasing film.

14. The shielding adhesive tape according to claim 1, further comprising:
a second mold releasing film adhered to a second surface of the shielding adhesive tape body and the second surface is opposed to the first surface.

15. The shielding adhesive tape according to claim 14, wherein the second surface of the shielding adhesive tape body has an adhesive layer and the second mold releasing film is adhered to the shielding adhesive tape body by the adhesive layer of the second surface, and wherein the adhesive layer is a black light absorption adhesive layer containing light absorption additives.

16. The shielding adhesive tape according to claim 14, wherein the second mold releasing film is a PET single sided mold releasing film.

17. A display apparatus, comprising:
a display panel;
a backlight module; and
the shielding adhesive tape according to claim 1 sandwiched between the display panel and the backlight module.

18. The display apparatus according to claim 17, wherein the display panel comprises a lower polarizer and an array substrate arranged sequentially from its light incidence side towards its light exit side, the lower polarizer having a lateral side located in a side of the array substrate facing towards the backlight module, and wherein there is a step structure formed between the lower polarizer and the array substrate;
wherein the shielding adhesive tape body is located on the backlight module and the remaining part of the first mold releasing film is sandwiched between the shielding adhesive tape body and the array substrate and the following inequality is satisfied:
30 μm≤(h₂−h₁)≤50 μm
wherein h₂ is a thickness of the lower polarizer and h₁ is a thickness of the remaining part of the first mold releasing film.

19. A method for producing a display apparatus, comprising:
providing a backlight module;
adhering the shielding adhesive tape according to claim 1 on the backlight module;
tearing the first mold releasing film while the remaining part defined by a cutting line on the first mold releasing film is cracked at the cutting line and remained on the shielding adhesive tape body; and
mounting a display panel above the shielding adhesive tape body and the remaining part of the first mold releasing film, wherein the shielding adhesive tape body separates the display panel from the backlight module and the remaining part of the first mold releasing film separates the shielding adhesive tape body from the display panel.

20. The method according to claim 19, further comprising a step of tearing away the second mold releasing film below the shielding adhesive tape body of the shielding adhesive tape before adhering the shielding adhesive tape to the backlight module.
